(19) United States
(12) Patent Application Publication
(10) Pub. No.: US 2026/0302475 A1
(43) Pub. Date: Oct. 1, 2026

(54) WAVY PLATE SPRING AND BATTERY MODULE

(71) Applicant: HONDA MOTOR CO., LTD., Tokyo (JP)

(72) Inventors: Hidemasa USUI, Saitama (JP); Hirokazu WATANABE, Saitama (JP)

(21) Appl. No.: 19/571,511

(22) Filed: Mar. 19, 2026

(30) Foreign Application Priority Data
Mar. 28, 2025 (JP) 2025-056786

(51) Int. Cl. H01M 50/242; B32B 5/02; B32B 5/26; B32B 27/12; B32B 27/38; B32B 37/10; H01M 4/134; H01M 10/0562; H01M 50/204; H01M 50/291; H01M 50/293

(52) U.S. Cl. CPC H01M 50/242; B32B 5/024; B32B 5/263; B32B 27/12; B32B 27/38; B32B 37/10; H01M 4/134; H01M 10/0562; H01M 50/204; H01M 50/291; H01M 50/293; B32B 2250/02; B32B 2250/20; B32B 2260/023; B32B 2260/046; B32B 2262/101; B32B 2305/076; B32B 2305/188; B32B 2307/7376; B32B 2363/00; B32B 2457/10

(57) ABSTRACT

Provided is a wavy plate spring having a recessed part and a projected part that are arranged alternately and continuously, and extended in a predetermined direction. The wavy plate spring includes two sheets of wavy sateen weave glass cloth and epoxy resin, and the two sheets of wavy sateen weave glass cloth are arranged such that surfaces having a higher ratio of warp yarns to weft yarns face each other.

This application is based on and claims the benefit of priority from Japanese Patent Application No. 2025-056786, filed on 28 Mar. 2025, the content of which is incorporated herein by reference.

### BACKGROUND OF THE INVENTION

### Field of the Invention

The present invention relates to a wavy plate spring and a battery module.

### Related Art

In recent years, research and development related to a battery module contributing to a greater efficiency of energy has been conducted to let many people secure access to sustainable and advanced energy that is affordable and reliable.

A battery module includes, for example, a battery cell stacked body in which a plurality of battery cells are stacked. In this regard, since a battery cell expands and contracts with charging and discharging, the battery module includes, for example, a pair of end plates provided at both ends in a stacking direction of the battery cell stacked body, and a bind bar that restrains the battery cell stacked body between the pair of end plates.

Patent Document 1 describes a power storage device including a power storage module that includes a plurality of power storage cells stacked in a stacking direction, a housing case that houses the power storage module, and a restriction unit arranged between the power storage cells. In this regard, the restriction unit includes a first flat plate and a second flat plate arranged in the stacking direction at an interval, and a corrugated plate arranged between the first flat plate and the second flat plate.

Patent Document 1: Japanese Unexamined Patent Application, Publication No. 2022-156427

### SUMMARY OF THE INVENTION

In this regard, by applying a corrugated plate made of glass fiber reinforced epoxy resin to the power storage device described in Cited Reference 1, when the restriction unit is compressed with expansion of the power storage cells at the time of charging, there is a risk of detachment between the glass fiber and the epoxy resin constituting the corrugated plate, or breaking of the epoxy resin. Thus, improvement in a flexural fracture strain of the corrugated plate made of glass fiber reinforced epoxy resin has been desired.

The purpose of the present invention is to provide a wavy plate spring capable of improving a flexural fracture strain.
(1) A wavy plate spring having a recessed part and a projected part that are arranged alternately and continuously, and extended in a predetermined direction, wherein the wavy plate spring comprises two sheets of wavy sateen weave glass cloth and epoxy resin, and the two sheets of wavy sateen weave glass cloth are arranged such that surfaces having a higher ratio of warp yarns to weft yarns face each other.
(2) The wavy plate spring according to (1), manufactured by press molding of two sheets of sheet-shaped sateen weave prepregs in an overlapping state, wherein the sheet-shaped sateen weave prepregs comprise a sheet-shaped sateen weave glass cloth and the epoxy resin.
(3) The wavy plate spring according to (1) or (2) as above, having a stacking structure in which a layer comprising the wavy sateen weave glass cloth and a layer comprising the epoxy resin are alternately stacked in a thickness direction, or a stacking structure in which a layer comprising the wavy sateen weave glass cloth and/or the epoxy resin is stacked in the thickness direction.
(4) The wavy plate spring according to any one of (1) to (3), wherein a thickness is 0.45 mm or more and 0.55 mm or less, and a flexural fracture strain is 3.8% or more.
(5) A battery module comprising: a battery cell stacked body in which a plurality of battery cells are stacked; a pair of plate-like members provided at both ends in a stacking direction of the battery cell stacked body; and an elastic member arranged between the plurality of battery cells, and/or between the battery cell stacked body and the plate-like members, wherein the elastic member comprises the wavy plate spring according to any one of (1) to (4).
(6) The battery module according to (5), wherein in the elastic member, a plurality of layers of the wavy plate springs are stacked in the stacking direction of the battery cell stacked body, and the recessed part and the projected part of the wavy plate springs that are adjacent face each other and contact each other.
(7) The battery module according to (5) or (6), wherein the battery cells are solid battery cells.
(8) The battery module according to any one of (5) to (7), wherein the battery cells comprise a negative electrode mixture layer including lithium metal or lithium alloy.

According to the present invention, a wavy plate spring capable of improving a flexural fracture strain can be provided.

### BRIEF DESCRIPTION OF THE DRAWINGS

FIG. 1 is a cross-sectional view showing a battery module according to an embodiment of the present invention;

FIG. 2 is a partially enlarged view of the battery module in FIG. 1;

FIG. 3 is an enlarged view of a wavy plate spring in FIG. 2;

FIG. 4 is a partially enlarged view of the wavy plate spring in FIG. 3;

FIG. 5 is a schematic diagram showing a surface having a higher ratio of warp yarns to weft yarns of a sateen weave glass cloth included in a first layer in FIG. 4;

FIG. 6 is a partially enlarged view of a modification of the wavy plate spring in FIG. 3;

FIG. 7 is a graph showing measurement results of flexural fracture strains of test pieces in Example 1 and Comparative Examples 1, 2;

FIG. 8A is an In-situ X-ray CT image at the time of pressurization of the test piece in Example 1;

FIG. 8B is an In-situ X-ray CT image at the time of pressurization of the test piece in Comparative Example 1; and

FIG. 9 is a graph showing measurement results of flexural fracture strains of test pieces in Example 2 and Comparative Examples 3, 4.

### DETAILED DESCRIPTION OF THE INVENTION

Hereinafter, embodiments of the present invention will be described with reference to the drawings.

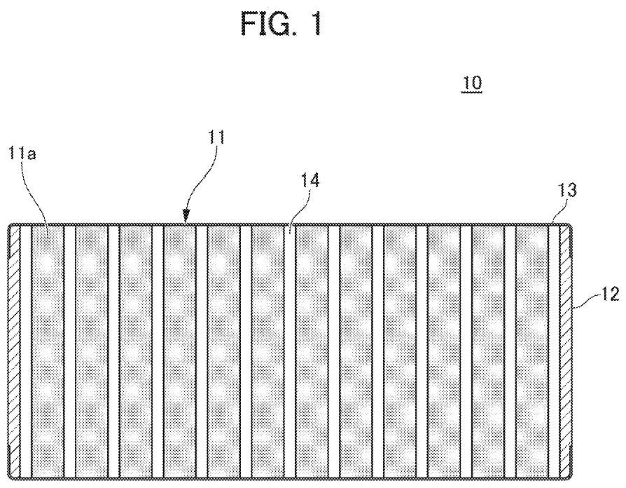

FIG. 1 shows a battery module according to an embodiment of the present invention.

A battery module 10 includes a battery cell stacked body 11 in which a plurality of battery cells 11a are stacked, end plates 12 as a pair of plate-like members provided at both ends in a stacking direction of the battery cell stacked body 11, and a bind bar 13 as a restraint member that restrains the battery cell stacked body 11 between the pair of end plates 12. In this embodiment, the bind bar 13 is installed at two places, which are an upper part and a lower part, in the figure.

In the battery module 10, an elastic member 14 is arranged between the plurality of battery cells 11a, and between the battery cell stacked body 11 and the end plates 12.

The elastic member 14 may be arranged between the plurality of battery cells 11a, or between the battery cell stacked body 11 and the end plates 12.

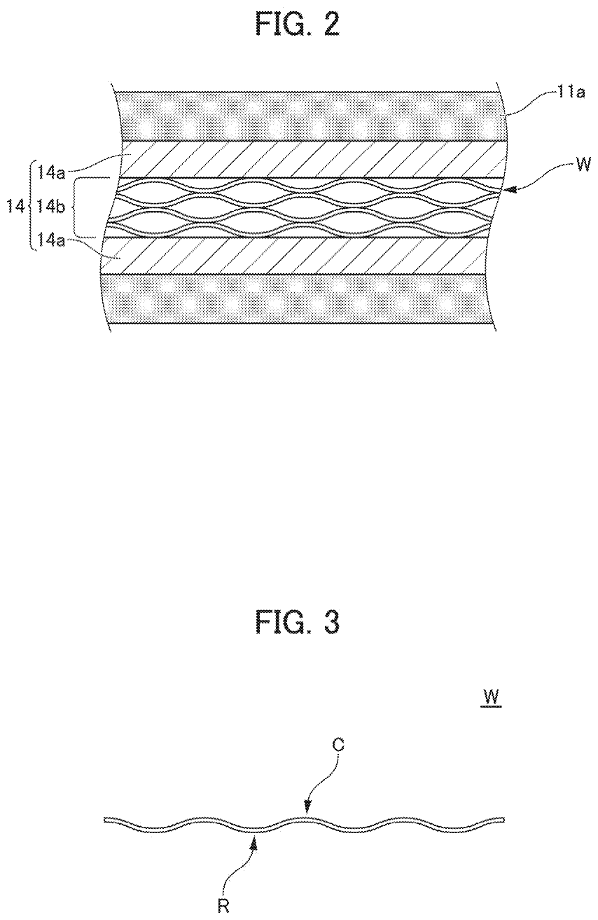

As shown in FIG. 2, the elastic member 14 includes a pair of first elastic members 14a arranged on both outer sides of the battery cell stacked body 11 in the stacking direction, and a second elastic member 14b arranged between the pair of first elastic members 14a. In addition, in the second elastic member 14b, four layers of a wavy plate spring W are stacked in the stacking direction of the battery cell stacked body 11. Thus, hysteresis loss of the elastic member 14 is reduced.

In this regard, when the elastic member 14 is compressed with expansion of the battery cells 11a at the time of charging, since the first elastic member 14a is interposed between the battery cells 11a and the second elastic member 14b, a difference in surface pressure between a part of the first elastic member 14a that is in contact with the second elastic member 14b and a part of the first elastic member 14a that is not in contact with the second elastic member 14b becomes smaller, and uniformity of the surface pressure becomes higher.

Examples of a method of fixing the second elastic member 14b to the first elastic member 14a include, but are not particularly limited to, a method of bonding the second elastic member 14b to the first elastic member 14a using an elastic adhesive.

The number of stacked wavy plate springs W is not limited to 4, and is preferably 2 or more and 6 or less, and more preferably 2 or more and 4 or less.

In addition, a part of a recessed part R and a projected part C of the adjacent wavy plate springs W, which are in contact so as to face each other, may be bonded using, for example, an elastic adhesive.

Furthermore, the wavy plate spring W may be used as the second elastic member 14b.

As shown in FIG. 3, the recessed part R and the projected part C of the wavy plate spring W are arranged alternately and continuously, and extended in a depth direction in the figure. In addition, in the second elastic member 14b, the recessed part R and the projected part C of the adjacent wavy plate springs W are in contact so as to face each other. The recessed part R and the projected part C are projected to the lower side and the upper side in the stacking direction of the battery cell stacked body 11, respectively.

The thickness of the wavy plate spring W is not particularly limited, but is 0.45 mm or more and 0.55 mm or less, for example. In addition, the height of the wavy plate spring W, i.e., the sum of the heights of the recessed part R and the projected part C is not particularly limited, but is 2.0 mm or more and 3.0 mm or less, for example.

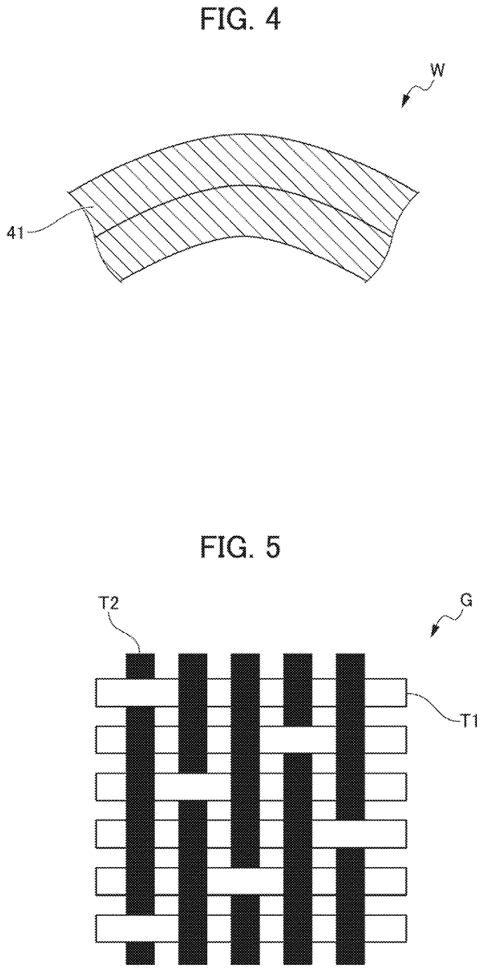

As shown in FIG. 4, the wavy plate spring W has a stacking structure in which a layer 41 including wavy sateen weave glass cloth and epoxy resin is stacked in the thickness direction. At this time, two sheets of wavy sateen weave glass cloth G are arranged such that surfaces having a higher ratio of warp yarns T2 to weft yarns T1 (see FIG. 5) face each other, and thus a flexural fracture strain of the wavy plate spring W becomes high.

The flexural fracture strain of the wavy plate spring W is preferably 3.8% or more, and more preferably 4.0% or more. If the flexural fracture strain of the wavy plate spring W is 3.8% or more, detachment at an interface of the layer 41 constituting the wavy plate spring W is less likely to occur when the elastic member 14 is compressed with expansion of the battery cells 11a at the time of charging.

The wavy plate spring W is manufactured by, for example, press molding of overlapped two sheets of sheet-shaped sateen weave prepregs obtained by impregnating a sheet-shaped sateen weave glass cloth with bisphenol A. Thus, the sheet-shaped sateen weave prepregs include the sheet-shaped sateen weave glass cloth and the epoxy resin.

The thickness of the sheet-shaped sateen weave prepreg is not particularly limited, but is 0.45 mm or more and 0.55 mm or less, for example.

The number of the weft yarns T1 or the warp yarns T2 between an intersecting point of the weft yarn T1 and the warp yarn T2 of the sateen weave glass cloth G is not particularly limited, but is 200 or more and 600 or less, for example. In addition, fiber diameters of the weft yarn T1 and the warp yarn T2 are not particularly limited, but are 5 μm or more and 7 μm or less, for example.

The surface of the sateen weave glass cloth G may be treated with a silane coupling agent. In this manner, the strength of the elastic member 14 becomes high.

Examples of the epoxy resin included in the layer 41 include, but are not particularly limited to, bisphenol A.

A mass ratio of the sateen weave glass cloth G to the epoxy resin in the wavy plate spring W is not particularly limited, but is 50% or more and 80% or less, for example.

A second layer including a styrene block copolymer or a cycloolefin polymer may exist between the stacked layers 41. In this regard, since a styrene block copolymer or a cycloolefin polymer has high adhesive property and flexibility against the sateen weave glass cloth G and the epoxy resin, when the elastic member 14 is compressed with expansion of the battery cells 11a at the time of charging, breaking is less likely to occur between the layer 41 and the second layer constituting the wavy plate spring W, and breaking of the second layer is also less likely to occur.

Examples of the styrene block copolymer included in the second layer include, but are not particularly limited to, a styrene-isoprene-styrene block copolymer (SIS), a styrene-ethylene-propylene-styrene block copolymer (SEPS), and a styrene-ethylene-butylene-styrene block copolymer (SEBS). Among these, SIS is preferable.

The cycloolefin polymer included in the second layer may be either of a homopolymer and a copolymer, and is not particularly limited.

The content of the styrene block copolymer or the cycloolefin polymer in the wavy plate spring W is not particularly limited, but is 15% by mass or less, for example.

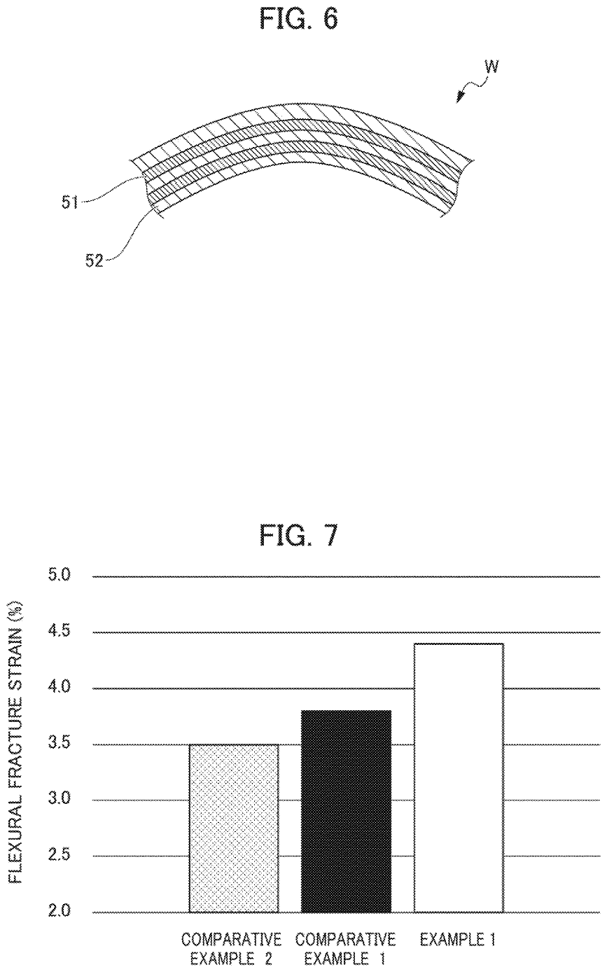

The wavy plate spring W is not particularly limited as long as the two sheets of wavy sateen weave glass cloth and the epoxy resin are included. As shown in FIG. 6, for example, the wavy plate spring W may have a stacking structure in which a first layer 51 including the wavy sateen weave glass cloth and a second layer 52 including the epoxy resin are alternately stacked in the thickness direction. At this time, a third layer including a styrene block copolymer or a cycloolefin polymer may exist between the first layer 51 and the second layer 52, which are stacked. In addition, the wavy plate spring W may have a stacking structure in which a layer including the wavy sateen weave glass cloth and/or the epoxy resin is stacked in the thickness direction. At this time, the second layer including the styrene block copolymer or the cycloolefin polymer may exist between the stacked layers.

A Poisson's ratio of the first elastic member 14a is preferably 0.3 or less. If the Poisson's ratio of the first elastic member 14a is 0.3 or less, a change of the thickness with expansion and contraction of the battery cells 11a is more easily absorbed by the first elastic member 14a. The Poisson's ratio of the first elastic member 14a is 0.01 or more, for example.

The thickness of the first elastic member 14a when the charging rate of the battery cells 11a is 100% is not particularly limited, but is 0.05 mm or more and 0.1 mm or less, for example.

The first elastic member 14a is a foam having a porosity of 30% or more and 95% or less, for example. Examples of a material forming the foam include, but are not particularly limited to, polyurethane, silicone resin, ethylene propylene rubber, styrene resin, olefin resin, polyamide, and polyester.

A Young's modulus of the second elastic member 14b is preferably 35 GPa or more. If the Young's modulus of the second elastic member 14b is 35 GPa or more, a change of the thickness with expansion and contraction of the battery cells 11a is more easily absorbed by the second elastic member 14b. The Young's modulus of the second elastic member 14b is 200 GPa or less, for example.

The thickness of the second elastic member 14b when the charging rate of the battery cells 11a is 100% is not particularly limited, but is 1.0 mm or more and 1.2 mm or less, for example.

Examples of the battery cells 11a include, but are not particularly limited to, a solid battery cell such as an all-solid battery cell or a semi-solid battery cell, and an electrolyte battery cell having a negative electrode mixture layer including lithium metal or lithium alloy. Examples of an element other than lithium constituting the lithium alloy include, but are not particularly limited to, Sn, Ag, Mg, In, Si, and Al. Among these, a solid battery cell having a negative electrode mixture layer including lithium metal or lithium alloy is preferable.

The case in which the battery cells 11a are all-solid battery cells will be described below.

In the all-solid lithium metal battery cell, for example, a positive electrode collector, a positive electrode mixture layer, a solid electrolyte layer, a negative electrode mixture layer including lithium metal or lithium alloy, and a negative electrode collector are successively stacked.

Examples of the positive electrode collector include, but are not particularly limited to, aluminum foil.

The positive electrode mixture layer includes a positive electrode active material, and may further include a solid electrolyte, a conductive assistant, a binding agent, etc.

Examples of the positive electrode active material include LiCoO₂, Li(Ni_{5/10}Co_{2/10}Mn_{3/10})O_{2,} Li(Ni_{6/10}Co_{2/10}Mn_{2/10})O_{2,} Li(Ni_{8/10}Co_{1/10}Mn_{1/10})O_{2,} Li(Ni_{0.8}Co_{0.15}Al_{0.05})O_{2,} Li(Ni_{1/6}Co_{4/6}Mn_{1/6})O_{2,} Li(Ni_{1/3}Co_{1/3}Mn_{1/3})O_{2,} LiCoO₄, LiMn₂O₄, LiNiO₂, LiFePO₄, lithium sulfide, and sulfur, but are not particularly limited to these as long as lithium ions can be occluded and discharged.

Examples of the solid electrolyte constituting the solid electrolyte layer include an oxide-based electrolyte and a sulfide-based electrolyte, but are not particularly limited to these as long as that material can conduct lithium ions.

Examples of the negative electrode collector include, but are not particularly limited to, copper foil.

Embodiments of the present invention have been described above, but the present invention is not limited to the above-described embodiments, and the above-described embodiments may be appropriately changed within the scope of the gist of the present invention.

### EXAMPLES

Hereinafter, Examples of the present invention will be described, but the present invention is not limited to the Examples. In the Examples, a flexural fracture strain is evaluated using a strip-shaped test piece representing the wavy plate spring W (see FIG. 4).

### Example 1

A strip-shaped test piece was prepared by stacking the layer 41 including a sheet-shaped sateen weave glass cloth constituting of warp yarns and weft yarns made of glass fiber having a fiber diameter of 7 μm, and bisphenol A. At this time, the direction of the warp yarns constituting the sateen weave glass cloth was regarded as the longitudinal direction of the test piece. Specifically, at first, a sateen weave prepreg was obtained by impregnating the sateen weave glass cloth with the bisphenol A. Then, the strip-shaped test piece was obtained by press molding of two sheets of the sateen weave prepregs in an overlapping state. At this time, the two sheets of the sateen weave glass cloth were arranged such that surfaces having a higher ratio of the warp yarns to the weft yarns face each other. In addition, the test piece had a thickness of 550 μm, and a mass ratio of the sateen weave glass cloth to the bisphenol A of 69%.

### Comparative Example 1

A strip-shaped test piece was obtained in the same manner as Example 1, except that the two sheets of the sateen weave glass cloth were arranged such that a surface having a higher ratio of the warp yarns to the weft yarns faces a surface having a lower ratio of the warp yarns to the weft yarns.

### Comparative Example 2

A strip-shaped test piece was obtained in the same manner as Example 1, except that the two sheets of the sateen weave glass cloth were arranged such that surfaces having a lower ratio of the warp yarns to the weft yarns face each other.

### Flexural Fracture Strain

A three-point bending test was conducted according to JIS K7171, and flexural fracture strains of the test pieces were measured. At this time, the direction of pressurization in the three-point bending test was set to be the direction perpendicular to the direction of the constituting warp yarns and weft yarns.

FIG. 7 shows measurement results of flexural fracture strains of the test pieces in Example 1 and Comparative Examples 1, 2.

From FIG. 7, it can be understood that the test pieces in Example 1 and Comparative Examples 1, 2 have flexural fracture strains of 4.4%, 3.7%, and 3.5%, respectively, and the test piece in Example 1 has a higher flexural fracture strain with respect to the test pieces in Comparative Examples 1, 2.

### In-Situ X-Ray CT Image at the Time of Pressurization

When measuring the flexural fracture strains of the test pieces, the test pieces were observed by using In-situ X-ray CT.

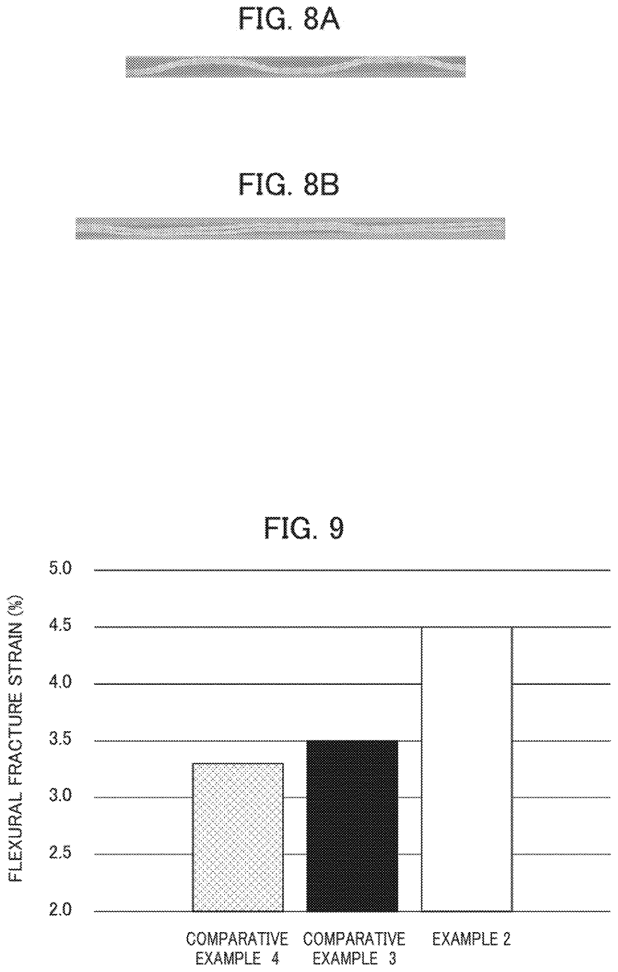

FIG. 8A and FIG. 8B show In-situ X-ray CT images of the test pieces in Example 1 and Comparative Example 1, respectively.

From FIG. 8A and FIG. 8B, it can be understood that detachment is not occurring at the interface of the layer 41 of the test piece in Example 1, while detachment is occurring at the interface of the layer 41 of the test piece in Comparative Example 1. It is inferred that this is because the flexural fracture strain of the test piece in Example 1 is higher than the flexural fracture strain of the test piece in Comparative Example 1.

### Example 2

A strip-shaped test piece was obtained in the same manner as Example 1, except that the thickness was set to 450 μm.

### Comparative Example 3

A strip-shaped test piece was obtained in the same manner as Example 2, except that the two sheets of the sateen weave glass cloth were arranged such that a surface having a higher ratio of the warp yarns to the weft yarns faces a surface having a lower ratio of the warp yarns to the weft yarns.

### Comparative Example 4

A strip-shaped test piece was obtained in the same manner as Example 2, except that the two sheets of the sateen weave glass cloth were arranged such that surfaces having a lower ratio of the warp yarns to the weft yarns face each other.

FIG. 9 shows measurement results of flexural fracture strains of the test pieces in Example 2 and Comparative Examples 3, 4.

From FIG. 9, it can be understood that the test pieces in Example 2 and Comparative Examples 3, 4 have flexural fracture strains of 4.5%, 3.5%, and 3.3%, respectively, and the test piece in Example 2 has a higher flexural fracture strain with respect to the test pieces in Comparative Examples 3, 4.

In addition, from FIG. 8 and FIG. 9, it can be understood that a similar tendency of the flexural fracture strains of the test pieces is seen even if the thickness of the test pieces is changed from 550 μm to 450 μm.

### EXPLANATION OF REFERENCE NUMERALS

10: battery module
11: battery cell stacked body
11a: battery cell
12: end plate
13: bind bar
14: elastic member
14a: first elastic member
14b: second elastic member
41: layer
51: first layer
52: second layer
W: wavy plate spring
R: recessed part
C: projected part
G: sateen weave glass cloth
T1: weft yarn
T2: warp yarn

What is claimed is:

1. A wavy plate spring having a recessed part and a projected part that are arranged alternately and continuously, and extended in a predetermined direction,
wherein the wavy plate spring comprises two sheets of wavy sateen weave glass cloth and epoxy resin, and
the two sheets of wavy sateen weave glass cloth are arranged such that surfaces having a higher ratio of warp yarns to weft yarns face each other.

2. The wavy plate spring according to claim 1, manufactured by press molding of two sheets of sheet-shaped sateen weave prepregs in an overlapping state,
wherein the sheet-shaped sateen weave prepregs comprise a sheet-shaped sateen weave glass cloth and the epoxy resin.

3. The wavy plate spring according to claim 1, having a stacking structure in which a layer comprising the wavy sateen weave glass cloth and a layer comprising the epoxy resin are alternately stacked in a thickness direction, or a stacking structure in which a layer comprising the wavy sateen weave glass cloth and/or the epoxy resin is stacked in the thickness direction.

4. The wavy plate spring according to claim 1, wherein a thickness is 0.45 mm or more and 0.55 mm or less, and
a flexural fracture strain is 3.8% or more.

5. A battery module comprising:
a battery cell stacked body in which a plurality of battery cells are stacked;
a pair of plate-like members provided at both ends in a stacking direction of the battery cell stacked body; and
an elastic member arranged between the plurality of battery cells, and/or between the battery cell stacked body and the plate-like members,
wherein the elastic member comprises the wavy plate spring according to claim 1.

6. The battery module according to claim 5, wherein in the elastic member, a plurality of layers of the wavy plate springs are stacked in the stacking direction of the battery cell stacked body, and the recessed part and the projected part of the wavy plate springs that are adjacent face each other and contact each other.

7. The battery module according to claim 5, wherein the battery cells are solid battery cells.

8. The battery module according to claim 5, wherein the battery cells comprise a negative electrode mixture layer including lithium metal or lithium alloy.
